(19) United States
(12) Patent Application Publication
(10) Pub. No.: US 2023/0275256 A1
(43) Pub. Date: Aug. 31, 2023

(54) ELECTROCHEMICAL CELL CLAMPS AND RELATED METHODS

(71) Applicant: Sion Power Corporation, Tucson, AZ (US)

(72) Inventors: Shane Harrel, Tucson, AZ (US); Daniel G. Milobar, Tucson, AZ (US); Wenzhuo Yang, Tucson, AZ (US)

(73) Assignee: Sion Power Corporation, Tucson, AZ (US)

(21) Appl. No.: 18/017,493

(22) PCT Filed: Aug. 2, 2021
(86) PCT No.: PCT/US2021/044142

§ 371 Date: Jan. 23, 2023

Related U.S. Application Data
(60) Provisional application No. 63/060,166, filed on Aug. 3, 2020.

(51) Int. Cl. H01M 10/04; H01M 10/0566; H01M 50/183

(52) U.S. Cl. CPC H01M 10/0481; H01M 10/0566; H01M 50/183; H01M 2220/20

(57) ABSTRACT

Clamps for electrochemical cells and related systems and methods are generally described. In some embodiments, a clamp system can apply a compressive clamp force to reinforce a contact between first and second portions of a container of an electrochemical cell (e.g., to reinforce a seal of an electrochemical cell pouch). In some embodiments, a clamp system can apply a compressive clamp force to reinforce electronic communication between an electrode tab and an electrode tab extension. Application of such compressive clamp forces via a clamp may assist with maintaining integrity of contacts (e.g., seals, electrode tab connections) under challenging conditions such as during testing of the electrochemical cell (e.g., at elevated temperatures) and/or during shipping.

### RELATED APPLICATIONS

This application claims priority under 35 U.S.C. § 119(e) to U.S. Provisional Patent Application No. 63/060,166, filed Aug. 3, 2020, and entitled “Electrochemical Cell Clamps and Related Methods,” which is incorporated herein by reference in its entirety for all purposes.

### TECHNICAL FIELD

Clamps for electrochemical cells and related systems and methods are generally described.

### BACKGROUND

Electrochemical cells typically include electrodes comprising electrode active materials that participate in an electrochemical reaction to produce electric current. Some electrochemical cells include containers with seals and/or electrical components such as electrode tabs. Certain embodiments of the present disclosure are directed to inventive methods, systems, and devices relating to reinforcing contacts between portions of electrochemical cell containers and/or electrical components.

### SUMMARY

Clamps for electrochemical cells and related systems and methods are generally described. In some embodiments, a clamp system can apply a compressive clamp force to reinforce a contact between first and second portions of a container of an electrochemical cell (e.g., to reinforce a seal of an electrochemical cell pouch). In some embodiments, a clamp system can apply a compressive clamp force to reinforce electronic communication between an electrode tab and an electrode tab extension. Application of such compressive clamp forces via a clamp may assist with maintaining integrity of contacts (e.g., seals, electrode tab connections) under challenging conditions such as during testing of the electrochemical cell (e.g., at elevated temperatures) and/or during shipping. The subject matter of the present invention involves, in some cases, interrelated products, alternative solutions to a particular problem, and/or a plurality of different uses of one or more systems and/or articles.

In one aspect, clamp systems for electrochemical cells are provided. In some embodiments, a clamp system for an electrochemical cell comprising electrodes at least partially enclosed by a flexible container comprises a lower clamp portion; an upper clamp portion coupled to the lower clamp portion; a platform adjacent to the lower clamp portion; the electrochemical cell on the platform, the electrochemical cell at least partially enclosed by a housing; and a compressible article between the lower clamp portion and the upper clamp portion; wherein: at least a portion of the flexible container of the electrochemical cell is between the lower clamp portion and the upper clamp portion; the electrochemical cell comprises lithium metal and/or a lithium metal alloy as an electrode active material during at least a portion of or during all of a charging and/or discharging process of the electrochemical cell; the electrochemical cell comprises an electrode tab and an electrode tab extension in electronic communication with at least one of the electrodes, at least a portion of the electrode tab being between the lower clamp portion and the upper clamp portion and extending through a seal between a first portion of the flexible container and a second portion of the flexible container; the lower clamp portion and the upper clamp portion are configured to apply a compressive clamp force to reinforce the seal and/or reinforce electronic communication between the electrode tab and the electrode tab extension; and the housing is configured to apply, during at least one period of time during charge and/or discharge of the electrochemical cell, an anisotropic force with a component normal to an electrode active surface of at least one electrode of the electrochemical cell.

In some embodiments, a clamp system for an electrochemical cell comprising electrodes at least partially enclosed by a flexible container comprises a lower clamp portion, an upper clamp portion coupled to the lower clamp portion, and a platform adjacent to the lower clamp portion capable of supporting the electrochemical cell, wherein the lower clamp portion and the upper clamp portion are configured to apply a compressive clamp force to reinforce a contact between a first portion of the flexible container and a second portion of the flexible container.

In some embodiments, a clamp system for an electrochemical cell comprising electrodes at least partially enclosed by a flexible container comprises a lower clamp portion, an upper clamp portion coupled to the lower clamp portion, and the electrochemical cell, wherein at least a portion of the flexible container of the electrochemical cell is between the lower clamp portion and the upper clamp portion, and wherein the lower clamp portion and the upper clamp portion are configured to apply a compressive clamp force to reinforce a contact between a first portion of the flexible container and a second portion of the flexible container.

In some embodiments, a clamp system for an electrochemical cell comprising an electrode in electronic communication with an electrode tab and an electrode tab extension comprises a lower clamp portion, an upper clamp portion coupled to the lower clamp portion, and the electrochemical cell, wherein at least a portion of the electrode tab and/or electrode tab extension is between the lower clamp portion and the upper clamp portion, and wherein the lower clamp portion and the upper clamp portion are configured to apply a compressive clamp force to reinforce electronic communication between the electrode tab and the electrode tab extension.

In another aspect, methods are provided. In some embodiments, a method comprises applying a compressive clamp force, via a clamp, to at least a portion of a flexible container containing electrodes and a liquid electrolyte, such that the compressive clamp force reinforces a contact between a first portion of the flexible container and a second portion of the flexible container.

In some embodiments, a method comprises applying a compressive clamp force, via a clamp, to at least a portion of a flexible container of an electrochemical cell such that the flexible container remains fluid-tight in at least one condition under which the flexible container would otherwise fail.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B show cross-sectional schematic diagrams of an exemplary clamp system comprising an upper clamp portion, a lower clamp portion, a platform, and an electrochemical cell, according to certain embodiments;

FIG. 2A shows top, side, and bottom view schematic illustrations of an exemplary clamp system comprising an upper clamp portion, a lower clamp portion, a platform, and an electrochemical cell, according to certain embodiments;

FIG. 2B shows a cross-sectional schematic illustration of an exemplary clamp system comprising an upper clamp portion, a lower clamp portion, a platform, and an electrochemical cell, according to certain embodiments;

FIG. 2C shows a perspective view schematic illustration of an exemplary clamp system comprising an upper clamp portion, a lower clamp portion, a platform, and an electrochemical cell, according to certain embodiments;

FIG. 2D shows an exploded perspective view schematic illustration of an exemplary clamp system comprising an upper clamp portion, a lower clamp portion, a platform, and an electrochemical cell, according to certain embodiments;

FIG. 3A shows a block schematic diagram of a battery comprising a clamp system, according to some embodiments;

FIG. 3B shows a cross sectional schematic diagram of an exemplary electric vehicle comprising a clamp system, according to some embodiments; and

FIG. 3C shows a cross sectional schematic diagram of an exemplary electric vehicle comprising a battery comprising a clamp system, according to some embodiments.

### DETAILED DESCRIPTION

Systems including clamps for electrochemical cells and related methods are generally described. In some embodiments, a clamp system can apply a compressive clamp force to reinforce a contact between first and second portions of a container of an electrochemical cell (e.g., to reinforce a seal of an electrochemical cell pouch). In some embodiments, a clamp system can apply a compressive clamp force to reinforce electronic communication between an electrode tab and an electrode tab extension. Application of such compressive clamp forces via a clamp may assist with maintaining integrity of contacts (e.g., seals, electrode tab connections) under challenging conditions such as during testing of the electrochemical cell (e.g., at elevated temperatures) and/or during shipping.

Electrochemical cells may be exposed to conditions tending to promote failure of one or more components of the electrochemical cell. For example, commercially distributed electrochemical cells (e.g., for batteries) may be required to undergo testing at elevated temperatures (e.g., greater than or equal to 40° C.) to evaluate performance and/or durability. In some instances, such elevated temperatures can promote failure of a seal of the electrochemical cell, due to, for example internal pressure generation. As one example, an electrochemical cell having a flexible container such as a foil pouch enclosing the electrodes and a liquid electrolyte may undergo internal gassing (e.g., due to boiling and/or thermal decomposition of the electrolyte). The gas may generate sufficient pressure to cause a seal of the electrical container to fail (e.g., due to a peeling force), which can cause deleterious phenomena such as electrolyte leakage and exposure of sensitive materials to the environment. It has been realized and observed in the context of this disclosure that certain clamp systems and configurations may be able to reduce or eliminate the tendency of internal pressure generation to cause contacts of portions of the flexible container (e.g., a seal) to fail at elevated temperatures.

Additionally, some electrochemical cells may have electrode tabs and electrode tab extensions in electronic communication with one or more electrodes of the electrochemical cell. Certain conditions may involve manipulation of the electrochemical cell that could disrupt electronic communication between the electrode tab and electrode tab extensions. For example, during shipping of the electrochemical cell, movement of the electrochemical cell (e.g., into and out of shipping containers) may lead to incidental forces breaking electrical connections and/or couplings (e.g., by bending or pulling). It has been realized and observed in the context of this disclosure that certain clamp systems and configurations may be used to reduce or eliminate the tendency of manipulation of the cell to disrupt electrical connections and/or couplings (e.g., by reinforcing electronic communication between the electrode tab and electrode tab extension).

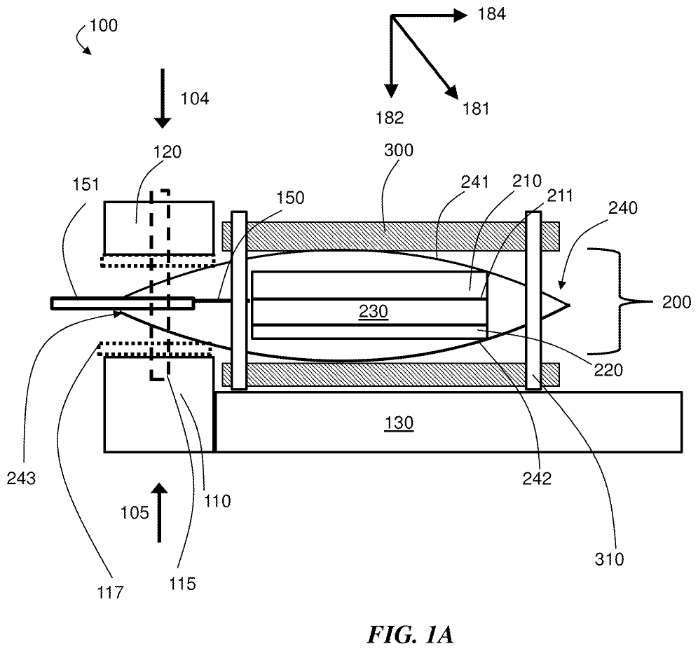

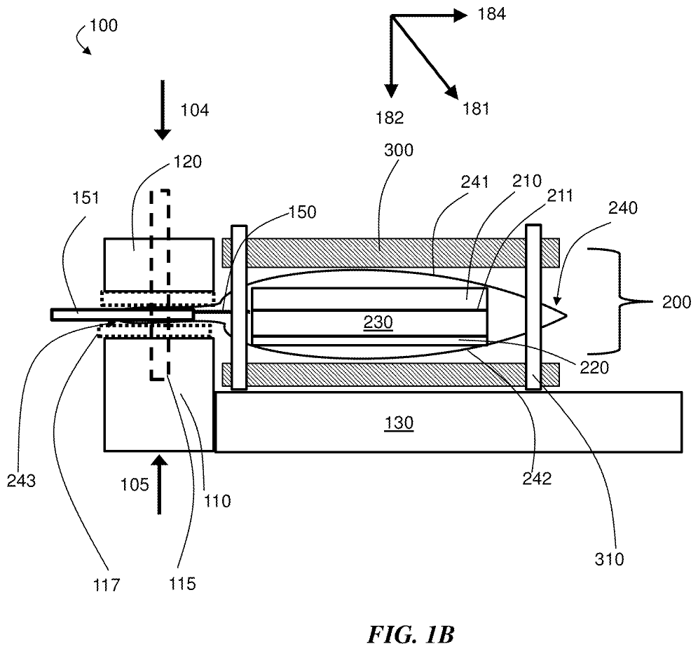

In some aspects, a clamp system for an electrochemical cell is provided. FIG. 1A shows a cross-sectional schematic diagram of clamp system 100 according to certain embodiments. As shown in FIG. 1A, clamp system 100 may be capable of applying a compressive clamp force to at least a portion of electrochemical cell 200 when present (e.g., to reinforce a contact during testing and/or shipping).

The electrochemical cell (e.g., to which a compressive clamp force may be applied via a clamp) may comprise electrodes. For example, FIG. 1A shows electrochemical cell 200 comprising first electrode 210 and second electrode 220. In some embodiments, first electrode 210 is an anode and second electrode 220 is a cathode. Exemplary anode and cathode materials are described in more detail below. In some embodiments, the electrodes of the electrochemical cell are at least partially enclosed by a flexible container, as is described in more detail below. Some aspects relate to applying a compressive clamp force, via a clamp (e.g., from clamp system 100), to reinforce a contact between portions of the flexible container (e.g., a seal of a pouch).

In some embodiments, the clamp system comprises a lower clamp portion and an upper clamp portion coupled to the lower clamp portion. The lower clamp portion and the upper clamp portion may be configured to apply compressive force (i.e., force pressing inward on an object such as by squeezing). Referring to FIGS. 1A-1B, lower clamp portion 110 and upper clamp portion 120 of clamp system 100 are configured to apply a compressive clamp force to at least a portion of electrochemical cell 200 according to arrow 104 and arrow 105, according to certain embodiments. In some embodiments, the lower clamp portion and the upper clamp portion are discrete, separate objects. However, in some embodiments, the lower clamp portion and the upper clamp portion are part of the same object. For example, in some embodiments, the lower clamp portion and the upper clamp portion are connected via a connecting clamp portion (e.g., having the same or similar composition to the lower clamp portion and/or the upper clamp portion). For example, the lower clamp portion and the upper clamp portion may each be portions of a clip.

The lower clamp portion and/or the upper clamp portion may be made of any of a variety of suitable materials based on, for example, criteria described in this disclosure. The materials from which the lower clamp portion and/or upper clamp portion are made may be able to withstand compressive clamp forces required for reinforcing contacts of the electrochemical cell (e.g., a seam, tab electronic connections, etc.), flexure associated with the compressive forces, and/or internal forces from the electrochemical cell (e.g., internal pressure from gassing). The materials may be selected to maintain integrity during and/or following electrochemical cell testing procedures, such as during exposure to elevated temperatures (e.g., greater than or equal to 40° C.). Exemplary materials for the lower clamp portion and/or the upper clamp portion include, but are not limited to, metals and/or metal alloys (e.g., aluminum and/or aluminum alloys, stainless steel), polymeric materials (e.g., plastics with sufficient mechanical properties and durability), composite materials (e.g., fiber-reinforced polymeric materials, carbon fiber), and combinations thereof. One non-limiting example of a suitable material for some embodiments is a composite material comprising a polymeric material (e.g., Nylon) and glass (e.g., in particulate and/or fiber form) in a suitable amount (e.g., glass present in an amount of 30 weight percent (wt %)). In some embodiments, the lower clamp portion and upper clamp portion have the same or similar compositions, though in other embodiments the lower clamp portion and the upper clamp portion have different compositions.

The materials from which the lower clamp portion and/or the upper clamp portion are made may be chosen based on any of a variety of mechanical or material properties. For example, the lower clamp portion and/or the upper clamp portion may have a relatively high ultimate tensile strength (e.g., greater than or equal to 50 MPa, greater than or equal to 100 MPa, greater than or equal to 150 MPa, and/or up to 200 MPa, up to 500 MPa, up to 1 GPa, up to 5 GPa, or greater). As another example, the lower clamp portion and/or the upper clam portion may have a relatively high Young's modulus (e.g., greater than or equal to 5 MPa, greater than or equal to 10 MPa, greater than or equal to 100 MPa, greater than or equal to 1 GPa, and/or up to 10 GPa, up to 100 GPa, up to 800 GPa, or greater). As yet another example, the lower clamp portion and/or the upper clam portion may have a relatively high glass transition temperature (e.g., greater than or equal to 20° C., greater than or equal to 50° C., greater than or equal to 60° C., greater than or equal to 70° C., and/or up to 80° C., up to 90° C., up to 100° C., up to 150° C., or higher).

Components of the clamp system (e.g., the lower clamp portion, the upper clamp portion, the optional platform described below) can be constructed using any of a variety of suitable techniques, such as via machining, milling, molding (e.g., injection molding), additive manufacturing (e.g., 3D-printing), etc.

In some embodiments, the lower clamp portion and the upper clamp portion are coupled via one or more fasteners. For example, in the embodiment shown in FIGS. 1A-1B, lower clamp portion 110 is coupled to upper clamp portion 120 via fastener 115. Any of a variety of suitable fasteners may be employed, such as a rod (e.g., a threaded rod, a rod with interlocking features), a bolt, a screw (e.g., a machine screw), a nail, a rivet, a tie, a clip (e.g., a side clip, a circlip), a band, or combinations thereof. The lower clamp portion and upper clamp portion may be coupled via at least 1, at least 2, at least 4, at least 8, or more fasteners. In some embodiments, application of a compressive clamp force (e.g., to reinforce a contact of the electrochemical cell) is caused by relative motion between components of the fastener or between the fastener and the lower clamp portion and/or the upper clamp portion. For example, compressive clamp force may be applied by turning a machine screw connecting the lower clamp portion and the upper clamp portion, or by turning a nut coupled to a rod or bolt connecting the lower clamp portion and the upper clamp portion.

In some embodiments, the clamp system comprises a compressible article between the lower clamp portion and the upper clamp portion. The compressible article may promote a relatively even application of the compressive clamp force from the clamp, which can ensure, in some instances, that sufficient pressure is applied at all desired locations being reinforced. Referring to FIGS. 1A-1B, in some embodiments, compressible article 117 is between lower clamp portion 110 and upper clamp portion 120. In some embodiments, a portion of the electrochemical cell (e.g., a portion of a flexible container of the electrochemical cell) is between a first compressible article and a second compressible article.

Any of a variety of materials may be used for the compressible article. In some embodiments, the compressible article is a solid article. The material used for the compressible article may be chosen based on an ability to effectively distribute compressive clamp force from the clamp (e.g., relatively evenly). In some embodiments, the compressible article comprises a foam (e.g., a microcellular foam). In some embodiments, the compressible article comprises a mesh. In some embodiments, the compressible article comprises a polymeric material. For example, the compressible article may comprise an elastomeric material. Elastomeric materials may be able to maintain elastic properties even after prolonged compressive stress. As one non-limiting example, the compressible article may comprise a polyurethane. Polyurethanes are polymers comprising organic repeat units linked by carbamate (urethane) units. Polyurethanes can be made using any of a variety of techniques, such as by reacting isocyanates and polyols. In some embodiments, the compressible article is or comprises a microcellular polyurethane foam (e.g., foam sheet or foam layer).

In some embodiments, the clamp system comprises a platform capable of supporting the electrochemical cell. The platform may be adjacent to the lower clamp portion. For example, FIGS. 1A-1B show platform 130 supporting electrochemical cell 200. In accordance with certain embodiments, platform 130 is adjacent to lower clamp portion 110. The platform and the lower clamp portion may be directly adjacent, with no intervening components present. In some embodiments, the platform is attached to the lower clamp portion. In some embodiments the platform and the lower clamp portion are discrete objects (e.g., attached via an adhesive and/or a fastener), while in some embodiments the platform and the lower clamp portion form a unitary structure. In some, but not necessarily all embodiments, the platform is made of any of the materials and fabricated according to any of the techniques described above with respect to the lower clamp portion and the upper clamp portion.

In some embodiments, a compressive clamp force is applied to at least a portion of a flexible container of the electrochemical cell. The flexible container, which may partially or completely enclose the electrochemical cell, may be made of any of a variety of suitable materials. The materials may be chosen based on criteria such as chemical compatibility with internal components of the electrochemical cell (e.g., compatibility with electrode active materials such as lithium metal and/or lithium alloys, compatibility with electrolyte materials), or physical properties such as having a relatively low mass density. The flexible container may be used to isolate internal components of the electrochemical cell (e.g., electrode active materials, electrolyte materials) from a surrounding environment (e.g., for safety, performance, and/or durability reasons). Flexibility of an object generally refers to an ability to bend or deform in response to an applied force. Flexibility is complementary to stiffness. That is, the more flexible an object is, the less stiff it is. The flexible container may have a relatively low stiffness. In some embodiments, the flexible container is made of a material having a relatively low Young's modulus (e.g., less than or equal to 100 GPa, less than or equal to 50 GPa, less than or equal to 10 GPa, less than or equal to 1 GPa, and/or as low as 100 MPa, as low as 50 MPa, as low as 10 MPa, or less). In some embodiments, the flexible container comprises a metal and/or metal alloy (e.g., aluminum and/or an aluminum alloy), a polymeric material, a composite material, or combinations thereof. For example, the flexible container may comprise a metal or metal alloy foil (e.g., an aluminum foil). In some embodiments, the flexible container comprises a multilayer composite material, such as a metal or metal alloy foil (e.g., an aluminum foil) with a lining comprising a polymeric material. In some instances, the flexible container is a pouch. For example, FIG. 1A shows an embodiment in which first electrode 210, second electrode 220, and separator 230 are enclosed by flexible container 240, where flexible container 240 is in the form of a pouch (e.g., a foil pouch).

Some aspects relate to applying a compressive clamp force, via a clamp, to at least a portion of a flexible container such that the compressive clamp force reinforces contact between a first portion of the flexible container and a second portion of the flexible container. FIG. 1B shows one such example, where lower clamp portion 110 and upper clamp portion 120 are configured to apply a compressive clamp force represented by arrow 104 and arrow 105 to flexible container 240 to reinforce contact 243 between first portion 241 of flexible container 240 and second portion 242 of flexible container 240. The clamp system (e.g., clamp system 100) may include at least a portion of the flexible container of the electrochemical cell between the lower clamp portion and the upper clamp portion. A magnitude of compressive clamp force applied via the clamp may depend on any of a variety of factors, such as expected internal pressure within the electrochemical cell or the strength of the contact (e.g., seal strength). In some embodiments, the compressive clamp force applied defines a pressure of greater than or equal to 0.1 kgf/cm², greater than or equal to 0.5 kgf/cm², greater than or equal to 1 kgf/cm², greater than or equal to 2 kgf/cm², greater than or equal to 3 kgf/cm², and/or up to 4 kgf/cm², up to 5 kgf/cm², up to 8 kgf/cm², up to 10 kgf/cm², or greater.

A contact between portions of the flexible container to be reinforced may be, for example, a seal between the portions. For example, in some embodiments, the lower clamp portion and the upper clamp portion are configured to apply a compressive clamp force to reinforce a seal between a first portion of the flexible container and a second portion of the flexible container.

A seal may be formed by connecting separate portions of the flexible container (e.g., separate sheets) such that fluid (e.g., liquid) may be prevented from flowing through the seal. For example, the flexible container at least partially enclosing electrodes of an electrochemical cell may be a pouch formed from sheets of metal foil. Regions of the sheets may be connected (e.g., via vacuum sealing, adhesives, welding, pressing, etc.) to prevent leakage of liquid (e.g., liquid electrolyte) inside the pouch. As mentioned above, certain conditions such as testing at elevated temperatures may cause internal forces within some electrochemical cells (e.g., internal pressure from gassing). In some instances, the internal forces may tend to cause the contact (e.g., seam) between portions of the flexible container to fail (e.g., breaking the seal).

Applying the compressive clamp force via the clamp to reinforce the contact may reduce or eliminate such problems. For example, the compressive clamp force may be applied to the flexible container such that the flexible container remains fluid-tight in at least one condition under which the flexible container would otherwise fail (e.g., exposure to elevated temperatures). The compressive clamp force may be applied by contacting the lower clamp portion and the upper clamp portion with the flexible container either at the contact (e.g., seal) or relatively close to the contact such that reinforcement is achieved (e.g., within 2 cm, within 1 cm, within 5 mm, within 1 mm, or less of the contact). Some or all of the contact (e.g., seal) may be reinforced by the compressive clamp force from the clamp. For example, the clamp may reinforce (e.g., with the compressive clamp force) greater than or equal to 10%, greater than or equal to 25%, greater than or equal to 50%, greater than or equal to 75%, greater than or equal to 90%, greater than or equal to 95%, greater than or equal to 99%, or 100% of the area defined by the contact between the first portion and second portion of the flexible container (e.g., area defined by the seal).

In some embodiments, the electrochemical cell comprises electrodes in electronic communication with an electrode tab. Those of ordinary skill in the art, with the benefit of this disclosure, would understand applicable electrode tab configurations and materials. The electrode tab may comprise an electronically conductive solid (e.g., a conductive metal such as copper and/or a copper alloy or aluminum and/or an aluminum alloy). The electrode tab may be in electronic communication with one or more electrodes of the electrochemical cell (e.g., via a current collector). FIGS. 1A-1B shows electrode tab 150 in electronic communication with first electrode 210 via a direct connection, according to certain embodiments. Electrode tabs are generally used as terminals to establish electronic communication (an ability for electronic current to flow) between the electrodes and external components (e.g., of a battery), such as a circuit board or other external circuitry. An electrochemical cell may comprise a first electrode tab in electronic communication with an anode and a second electrode tab in electronic communication with a cathode.

In some embodiments, the electrode tab is in electronic communication with an electrode tab extension. The electrode tab may be in direct or indirect contact with the electrode tab extension (e.g., via welding or crimping). An electrode tab extension, which may be a separate electronically conductive material (e.g., electronically conductive solid), can facilitate electronic communication between the electrode tab and external components by extending a larger distance from the electrodes than does the electrode tab. Such an extension may allow for more convenient connectivity and greater configurational flexibility (e.g., with respect to battery design). FIGS. 1A-1B depict optional electrode tab extension 151 in electronic communication with electrode tab 150 via a direct connection, according to certain embodiments. In some embodiments in which a flexible container at least partially encloses the electrodes, a portion of the electrode tab extension and/or the electrode tab extends through a seal of the flexible container and is between the lower clamp portion and the upper clamp portion. FIGS. 1A-1B show one such embodiment, where electrode tab extension 151 extends through contact 243 between first portion 241 and second portion 242 of flexible container 240. It has been observed that contacts between portions of the flexible container (e.g., a seal) through which an electrode tab and/or electrode tab extension extends may be particularly susceptible to failure under certain conditions (e.g., testing at elevated temperatures). Therefore, applying a compressive clamp force to such a contact having an electrode tab and/or electrode tab extension, in the manner described herein, may be advantageous in some instances. In some embodiments, a compressive clamp force is applied via the clamp along a pathway that traverses the width of one, more, or all of the electrode tabs and/or one, more, or all of the electrode tab extensions. In some instances, such application of compressive clamp force assists with reinforcing the entirety of the seal associated with the electrode tabs and/or electrode tab extensions. In some embodiments, a compressive clamp force is applied via the clamp along a pathway that isolates at least a portion (e.g., at least 50%, at least 75 wt %, at least 90 wt %, at least 95 wt %, at least 99 wt %, or all) of an electrolyte (when present) from a seal of the flexible container (e.g., a seal between a portion of the flexible container and an electrode tab and/or electrode tab extension). For example, in FIG. 1B, a compressive clamp force represented by arrow 104 and arrow 105 may isolate contact 243 (a seal between first portion 241 and electrode tab extension 151) from an electrolyte within flexible container 240, according to certain embodiments.

In some embodiments, application of the compressive clamp force, via the clamp, reinforces electronic communication between the electrode tab and the electrode tab extension. As mentioned above, an electrochemical cell may be exposed to conditions (e.g., shipping or user manipulation) that could otherwise disrupt electronic communication between the electrode tab and the electrode tab extension (e.g., by pulling or bending). The clamp system may be configured to reinforce electronic communication by providing a compressive clamp force that stabilizes the electrode tab and electrode tab extension (e.g., by a resisting pulling, bending or other potentially disruptive forces). The clamp system may accomplish this when at least a portion of the electrode tab and/or electrode tab extension is between the lower clamp portion and the upper clamp portion. The lower clamp portion and the upper clamp portion may be configured to apply a compressive clamp force (e.g., to at least a portion of the electrochemical cell) to reinforce electronic communication between the electrode tab and the electrode tab extension. For example, referring back to FIG. 1B, lower clamp portion 110 and upper clamp portion 120 (or compressible article 117 associated with lower clamp portion 110 or upper clamp portion 120) may contact electrochemical cell 200 at or relatively close to (e.g., within 2 cm, within 1 cm, within 5 mm, within 1 mm) at least a portion of electrode tab 150 and/or electrode tab extension 151.

In some embodiments in which the electrochemical cell comprises a liquid electrolyte, it may be beneficial to prevent or reduce the occurrence of the liquid electrolyte contacting the electrode tab, as such contact may disrupt the performance and/or durability of the electrochemical cell. In some embodiments, applying the compressive clamp force via the clamp is performed such that at least a portion (e.g., at least 50%, at least 75 wt %, at least 90 wt %, at least 95 wt %, at least 99 wt %, or all) of the external surface area of the electrode tabs and/or electrode tab extensions is isolated from at least a portion (e.g., at least 50%, at least 75 wt %, at least 90 wt %, at least 95 wt %, at least 99 wt %, or all) of the liquid electrolyte. As an illustrative example, the clamp may apply a compressive clamp force to at least a portion of the flexible container (e.g., a foil pouch) and press together portions of the flexible container proximate to the electrode tab, thereby preventing at least a portion of the liquid electrolyte from accessing at least a portion of the external surface area of the electrode tabs and/or electrode tab extensions.

Some embodiments are related to applying, during at least one period of time during charge and/or discharge of the electrochemical cell, an anisotropic force with a component normal to an electrode active surface of at least one electrode of the electrochemical cell. It should be understood that such an anisotropic force with a component normal to an electrode active surface is performed such that one or more electrodes experiences a pressure defined by the anisotropic force, and is a distinct and separate force from the compressive clamp force applied via the clamp (e.g., via the lower clamp portion and the upper clamp portion) for reinforcing contacts (e.g., seals, electronic connections/couplings). In some embodiments, the compressive clamp force and the anisotropic force with a component normal to an electrode active surface are applied simultaneously, though in some embodiments there is at least one period of time during which the compressive clamp force is applied but during which the anisotropic force with a component normal to an electrode active surface is not applied.

Application of such an anisotropic force with a component normal to an electrode active surface may reduce potentially deleterious phenomena associated with certain types of electrochemical cells (e.g., cells comprising lithium metal as an electrode active material) and improve utilization. For example, in some cases, applying an anisotropic force with a component normal to an active surface of an electrode of the electrochemical cell can reduce problems (such as surface roughening of the electrode and dendrite formation) while improving current density. Electrochemical devices in which anisotropic forces with a component normal to an electrode active surface are applied and methods for applying such forces are described, for example, in U.S. Pat. No. 9,105,938, issued Aug. 11, 2015, published as U.S. Patent Publication No. 2010/0035128 on Feb. 11, 2010, and entitled “Application of Force in Electrochemical Cells,” which is incorporated herein by reference in its entirety for all purposes.

Referring to FIGS. 1A-1B depicts schematic illustrations of an anisotropic force that may be applied to electrochemical 200 cell in the direction of arrow 181. Arrow 182 illustrates the component of force 181 that is normal to active surface 211 of first electrode 210, according to certain embodiments.

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes certain forces applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

A force with a “component normal” to a surface, for example an active surface of an electrode such as an anode, is given its ordinary meaning as would be understood by those of ordinary skill in the art and includes, for example, a force which at least in part exerts itself in a direction substantially perpendicular to the surface. Those of ordinary skill can understand other examples of these terms, especially as applied within the description of this document.

Some embodiments comprise applying an anisotropic force (e.g., via a housing) with a component normal to an electrode active surface of an electrode of the electrochemical cell defining a pressure of at least 10 kgf/cm², (e.g., at least 12 kgf/cm², at least 20 kgf/cm², at least 25 kgf/cm², or more) and/or up to 40 kgf/cm² (e.g., up to 35 kgf/cm², up to 30 kgf/cm²).

In some embodiments, the electrochemical cell is at least partially enclosed by a housing. FIGS. 1A-1B shows optional housing 300 at least partially enclosing electrochemical cell 200, according to certain embodiments. The housing may comprise rigid components. As one example, the housing may comprise one or more solid plates (e.g., endplates). The solid plate may comprise any of a variety of suitable solid materials, such as a metal (e.g., aluminum), metal alloy (e.g., stainless steel), composite material (e.g., carbon fiber), or a combination thereof. It should be understood that the surfaces of a solid plate do not necessarily need to be flat. For example, one of the sides of the solid plate may comprise a surface that is curved (e.g., contoured, convex) in the absence of an applied force with a component normal to an electrode active surface. In some embodiments, the solid plate (e.g., an aluminum solid plate, carbon fiber solid plate) is convex with respect to the electrochemical cells in the absence of an applied force with a component normal to an electrode active surface, and under at least one magnitude of applied force with a component normal to an electrode active surface the end plate may become less convex (e.g., become flat).

In certain cases, the housing does not comprise a solid plate. For example, in some cases, the solid surfaces and other components of a containment structure configured to house the electrochemical cell and deformable solid are part of a unitary structure.

The housing may comprise couplings that can be used to connect components of the housing and/or apply at least a portion of the anisotropic force with a component normal to an electrode active surface. The housing may comprise, for example, couplings proximate to the ends of the housing (e.g., proximate to the ends of the solid plates). Coupling 310 (e.g., a rod or screw) in FIG. 1A is one non-limiting example. A coupling may connect a first solid plate and a second solid plate. In some embodiments, the housing has more than one coupling. In certain cases, the housing includes at least 2 couplings, at least 4 couplings, and/or up to 8 couplings or more. In some embodiments, the coupling comprises a fastener. The fastener may span from one end of the housing to another. Exemplary fasteners include, but are not limited to, a rod (e.g., a threaded rod, a rod with interlocking features), a bolt, a screw (e.g., a machine screw), a nail, a rivet, a tie, a clip (e.g., a side clip, a circlip), a band, or combinations thereof.

In some embodiments, the housing at least partially enclosing the electrochemical cell is configured to apply, during at least one period of time during charge and/or discharge of the electrochemical cell, an anisotropic force having component normal to electrode active surfaces of at least one (or all) of the electrodes of the electrochemical cell. The magnitude of the component normal to the electrode active surface may be relatively high. For example, in some embodiments, the housing is configured to apply an anisotropic force having a relatively high magnitude component normal to an anode active surface of an anode of the electrochemical cell. The housing may be configured to apply such an anisotropic force in a variety of ways. For example, in some embodiments, the housing comprises two solid articles (e.g., a first solid plate and a second solid plate). An object (e.g., a machine screw, a nut, a spring, etc.) may be used to apply the anisotropic force with a component normal to an electrode active surface by applying pressure to the ends (or regions near the ends) of the housing. In some cases, applying an anisotropic force with a component normal to an electrode active surface via a housing comprises causing relative motion between a portion of the coupling (e.g., a nut) and a fastener of the coupling (e.g., by tightening a nut at an interface between the fastener and the solid plate). In the case of a machine screw, for example, the electrochemical cell and other components (e.g., compressible solids, sensors, etc.) may be compressed between the plates (e.g., a first solid plate and a second solid plate) upon rotating the screw. As another example, in some embodiments, one or more wedges may be displaced between the housing and a fixed surface (e.g., a tabletop, etc.). The anisotropic force may be applied by driving the wedge between the housing (e.g., between a solid plate of a containment structure of the housing) and the adjacent fixed surface through the application of force on the wedge (e.g., by turning a machine screw).

In some embodiments, the lower clamp portion, the upper clamp portion, and the platform are configured to complement the shape of the housing. For example, in FIGS. 1A-1B, lower clamp portion 110, upper clamp portion 120, and platform 130 may be positioned and have dimensions such that when electrochemical cell 200 is at least partially enclosed by housing 300 and housing 300 is supported by platform 130, at least a portion of electrochemical cell 200 can be readily positioned between lower clamp portion 110 and upper clamp portion 120.

As mentioned above, in certain instances, an electrochemical cell may be exposed to relatively high temperatures. For example, during some testing procedures for some electrochemical cells, the cells may be heated in environments having elevated temperatures. Such elevated temperatures may tend to cause failure of components of the electrochemical cell, such as contacts between portions of certain flexible containers due to, for example, internal pressure generation. In some instances, a compressive clamp force is applied via a clamp to reinforce contacts of the electrochemical cell (e.g., a seam of the flexible container) during such heating. The reinforcement may resist the internal forces experienced by the electrochemical cell and avoid (or limit the extent of) failure of the flexible container (such as failure of a fluid-tight seal).

In some embodiments, the electrochemical cell is heated in an environment having a temperature of greater than or equal to 40° C., greater than or equal to 45° C., greater than or equal to 50° C., greater than or equal to 60° C., and/or up to 65° C., up to 70° C., up to 75° C., up to 80° C., or higher. In some embodiments in which the electrochemical cell comprises an electrolyte, the electrochemical cell is heated in an environment having a temperature greater than a decomposition temperature of the electrolyte. In some embodiments in which the electrochemical cell comprises a liquid electrolyte, the electrochemical cell is heated in an environment having a temperature greater than a boiling point of the liquid electrolyte. The materials from which the clamp system is made may be chosen to maintain integrity in environments having the temperature ranges described above. The heating may occur, for example, in a test chamber (e.g., an enclosure with a configurable temperature environment). In some embodiments, the electrochemical cell undergoes a charging and/or discharging process in the elevated temperature environment (e.g., during testing).

As mentioned above, in some instances, an electrochemical cell may be exposed to conditions that contribute to the generation of internal pressure within the electrochemical cell. Such internal pressure may tend to cause failure of components of the electrochemical cell, such as contacts between portions of certain flexible containers. Reinforcement of such contacts (e.g., seals) via compressive force from the clamp may reduce or avoid deleterious effects from the internal pressure generation. In some, but not necessarily all embodiments, an internal pressure inside the electrochemical cell of greater than or equal to 414 kPa (60 psi), greater than or equal to 517 kPa (75 psi), greater than or equal to 621 kPa (90 psi), and/or as high as 689 kPa (100 psi), as high as 1.03 MPa (150 psi), as high as 1.38 MPa (200 psi), or higher is generated. The internal pressure generated under given conditions may depend on the chemistry of the electrochemical cell. For example, some combinations of anode active materials, electrode active materials, or electrolyte materials may have an increased propensity for generating pressure (e.g., via gassing) for a given set of conditions (e.g., temperature) than other combinations of materials.

In some such embodiments, internal pressures in these ranges are generated, but the flexible container of the electrochemical cell avoids failure (e.g., remains fluid-tight) due at least in part to the application of a compressive clamp force via the clamp. In some embodiments a sum of the seal strength of the seal and the compressive clamp force is greater than or equal to a force on the seal from the internal pressure.

In some embodiments, the electrochemical cell is cycled during the application of the compressive clamp force. Cycling the electrochemical cell may comprise a charging event (e.g., charging with an external power source or charger by applying a voltage to the electrochemical cell) and a discharging event (e.g., an electrochemical reaction between anode active material and cathode active material that generates electricity). In certain cases, cycling the electrochemical cell while applying the compressive clamp force (e.g., to at least a portion of the flexible container and/or another portion of the electrochemical cell) can be performed without failure of the flexible container (and/or electronic connections such as between an electrode tab and an electrode tab extension). Such a lack of failure may be due at least part to the compressive clamp force from the clamp reinforcing a contact of the flexible container (e.g., a seal) and/or an electrical contact. In some embodiments, the electrochemical cell of the systems and methods described herein is cycled during the application of the anisotropic force (e.g., via the housing) having a component normal to at least one electrode active surface of an electrode of the electrochemical cell.

Some aspects relate to shipping electrochemical cells (e.g., transporting electrochemical cells from a first location to a second, different location such as for commercial distribution or for sending to testing facilities during or after manufacturing). In some, but not necessarily all embodiments, clamp systems described herein are located within a shipping container (e.g., a rigid box or a shipping crate). As mentioned above, aspects of the clamp systems and related methods described herein may reduce or prevent damage to an electrochemical cell during shipping, such as disruption of electronic couplings between cell components such as electrode tabs and electrode tab extensions (e.g., by mechanically stabilizing contacts).

As mentioned above, the electrochemical cell comprises electrodes (e.g., a first electrode, a second electrode). At least one of the electrodes may be an anode comprising an anode active material. As used herein, an “anode active material” refers to any electrochemically active species associated with an anode. A variety of anode active materials are suitable for use with the anodes of the electrochemical cell. In some embodiments, the anode active material comprises lithium (e.g., lithium metal), such as lithium foil, lithium deposited onto a conductive substrate or onto a non-conductive substrate (e.g., a release layer), and lithium alloys (e.g., lithium-aluminum alloys and lithium-tin alloys). Lithium can be contained as one film or as several films, optionally separated. Suitable lithium alloys for use in the aspects described herein can include alloys of lithium and aluminum, magnesium, silicium (silicon), indium, and/or tin. In some embodiments, the anode active material comprises lithium (e.g., lithium metal and/or a lithium metal alloy) during at least a portion of or during all of a charging and/or discharging process of the electrochemical cell.

At least one of the electrodes (e.g., first electrode, second electrode) may be a cathode comprising a cathode active material. As used herein, a “cathode active material” refers to any electrochemically active species associated with a cathode. In certain cases, the cathode active material may be or comprise a lithium intercalation compound (e.g., a metal oxide lithium intercalation compound). As one non-limiting example, in some embodiments, an electrode (e.g., first electrode, second electrode) comprises a nickel-cobalt-manganese lithium intercalation compound.

In some embodiments, the cathode active material comprises one or more metal oxides. In some embodiments, an intercalation cathode (e.g., a lithium-intercalation cathode) may be used. Non-limiting examples of suitable materials that may intercalate ions of an electroactive material (e.g., alkaline metal ions) include metal oxides, titanium sulfide, and iron sulfide. In some embodiments, the cathode is an intercalation cathode comprising a lithium transition metal oxide or a lithium transition metal phosphate. Additional examples include LiₓCoO₂ (e.g., Li_{1.1}CoO₂), LiₓNiO₂, LiₓMnO₂, LiₓMn₂O₄ (e.g., Li_{1.05}Mn₂O₄), LiₓCoPO₄, LiₓMnPO₄, LiCoₓNi₍₁₋ₓ₎O₂, and LiCoₓNi_{y}Mn(_{1-x-y)}O₂ (e.g., LiNi_{1/3}Mn_{1/3}Co_{1/3}O₂, LiNi_{3/5}Mn_{1/5}Co_{1/5}O₂, LiNi_{4/5}Mn_{1/10}Co_{1/10}O₂, LiNi_{1/2}Mn_{3/10}Co_{1/5}O₂). X may be greater than or equal to 0 and less than or equal to 2. X is typically greater than or equal to 1 and less than or equal to 2 when the electrochemical cell is fully discharged, and less than 1 when the electrochemical cell is fully charged. In some embodiments, a fully charged electrochemical cell may have a value of x that is greater than or equal to 1 and less than or equal to 1.05, greater than or equal to 1 and less than or equal to 1.1, or greater than or equal to 1 and less than or equal to 1.2. Further examples include LiₓNiPO₄, where (0<x≤1), LiMnₓNi_{y}O₄ where (x+y=2) (e.g., LiMn_{1.5}Ni_{0.5}O₄), LiNiₓCo_{y}Al_{z}O₂ where (x+y+z=1), LiFePO₄, and combinations thereof. In some embodiments, the electroactive material within the cathode comprises lithium transition metal phosphates (e.g., LiFePO₄), which can, in certain embodiments, be substituted with borates and/or silicates.

As noted above, in some embodiments, the cathode active material comprises one or more chalcogenides. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a cathode includes one or more of the following materials: manganese dioxide, iodine, silver chromate, silver oxide and vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Examples of conductive polymers include polypyrroles, polyanilines, and polyacetylenes.

In some embodiments, electroactive materials for use as cathode active materials in electrochemical cells described herein include electroactive sulfur-containing materials. “Electroactive sulfur-containing materials,” as used herein, relates to cathode active materials which comprise the element sulfur in any form, wherein the electrochemical activity involves the oxidation or reduction of sulfur atoms or moieties. The nature of the electroactive sulfur-containing materials useful in the practice of some embodiments may vary widely, as known in the art. For example, in one embodiment, the electroactive sulfur-containing material comprises elemental sulfur. In another embodiment, the electroactive sulfur-containing material comprises a mixture of elemental sulfur and a sulfur-containing polymer. Thus, suitable electroactive sulfur-containing materials may include, but are not limited to, elemental sulfur and organic materials comprising sulfur atoms and carbon atoms, which may or may not be polymeric. Suitable organic materials include those further comprising heteroatoms, conductive polymer segments, composites, and conductive polymers. Additional materials suitable for use in the cathode, and suitable methods for making the cathodes, are described, for example, in U.S. Pat. No. 5,919,587, filed May 21, 1997, entitled “Novel Composite Cathodes, Electrochemical Cells Comprising Novel Composite Cathodes, and Processes for Fabricating Same,” and U.S. Patent Publication No. 2010/0035128 to Scordilis-Kelley et al. filed on Aug. 4, 2009, entitled “Application of Force in Electrochemical Cells,” each of which is incorporated herein by reference in its entirety for all purposes.

As used herein, “cathode” refers to the electrode in which an electrode active material is oxidized during charging and reduced during discharging, and “anode” refers to the electrode in which an electrode active material is reduced during charging and oxidized during discharging.

In some embodiments, the electrochemical cell further comprises a separator between two electrode portions (e.g., an anode portion and a cathode portion). Referring back to FIG. 1A, for example, electrochemical cell 200 may comprise separator 230 between first electrode 210 and second electrode 220. The separator may be a solid non-conductive or insulative material which separates or insulates the anode and the cathode from each other preventing short circuiting, and which permits the transport of ions between the anode and the cathode. In some embodiments, the porous separator may be permeable to the electrolyte.

The pores of the separator may be partially or substantially filled with electrolyte. Separators may be supplied as porous free-standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A variety of separator materials are known in the art. Examples of suitable solid porous separator materials include, but are not limited to, polyolefins, such as, for example, polyethylenes (e.g., SETELA™ made by Tonen Chemical Corp) and polypropylenes, glass fiber filter papers, and ceramic materials. For example, in some embodiments, the separator comprises a microporous polyethylene film. Further examples of separators and separator materials suitable for use in this invention are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545 by Carlson et al. of the common assignee. Solid electrolytes and gel electrolytes may also function as a separator in addition to their electrolyte function.

As mentioned above, in some embodiments, the electrochemical cell comprises a liquid electrolyte. The liquid electrolyte may have a composition that, under certain conditions, generates gas either due to boiling or decomposition into gaseous products. In some embodiments, the liquid electrolyte comprises an organic solvent. Examples of suitable organic solvents include, but are not limited to, dimethyl carbonate, diethyl carbonate, ethyl-methyl carbonate, ethylene carbonate, and propylene carbonate. In some embodiments, the electrolyte comprises one or more solid polymers. In some cases, the electrolyte further comprises a lithium salt. Non-limiting examples of suitable lithium salts include lithium hexafluorophosphate (LiPF₆), lithium tetrafluoroborate (LiBF₄), lithium perchlorate (LiClO₄), lithium hexafluoroarsenate monohydrate (LiAsF₆), lithium triflate (LiCF₃SO₃), LiN(SO₂CF₃)₂, and LiC(SO₂CF₃)₃. In some embodiments, the liquid electrolyte comprises organic compounds having ester functional groups, and further comprises hexafluorophosphate salts (e.g., lithium hexafluorophosphate).

In some embodiments, a clamp system for an electrochemical cell comprising electrodes at least partially enclosed by a flexible container comprises a lower clamp portion, an upper clamp portion coupled to the lower clamp portion, and a platform adjacent to the upper clamp portion. The clamp system may further comprise the electrochemical cell, at least partially enclosed by a housing, on the platform. The electrochemical cell may comprise lithium metal and/or a lithium metal alloy as an electrode active material during at least a portion of or during all of a charging and/or discharging process of the electrochemical cell. At least a portion of the flexible container at least partially enclosing the electrodes may be between the lower clamp portion and the upper clamp portion. The electrochemical cell may further comprise an electrode tab and an electrode tab extension in electronic communication with at least one of the electrodes. At least a portion of the electrode tab may extend through a seal between first and second portions of the flexible container, and in some cases may be between the lower clamp portion and the upper clamp portion. In some embodiments, a compressible article is between the lower clamp portion and the upper clamp portion (e.g., such that a relatively uniform force distribution across at least one dimension of the flexible container is achieved). In some embodiments, the lower clamp portion and the upper clamp portion are configured to apply a compressive clamp force to reinforce the seal (e.g., such that failure of a fluid-tight seal is prevented under at least some conditions where failure might otherwise occur). In some embodiments, the lower clamp portion and the upper clamp portion are configured to apply a compressive clamp force to reinforce electronic communication between the electrode tab and the electrode tab extension. In some embodiments, the housing may be configured to apply, during at least one period of time during charge and/or discharge of the electrochemical cell, an anisotropic force with a component normal to an electrode active surface of at least one electrode of the electrochemical cell.

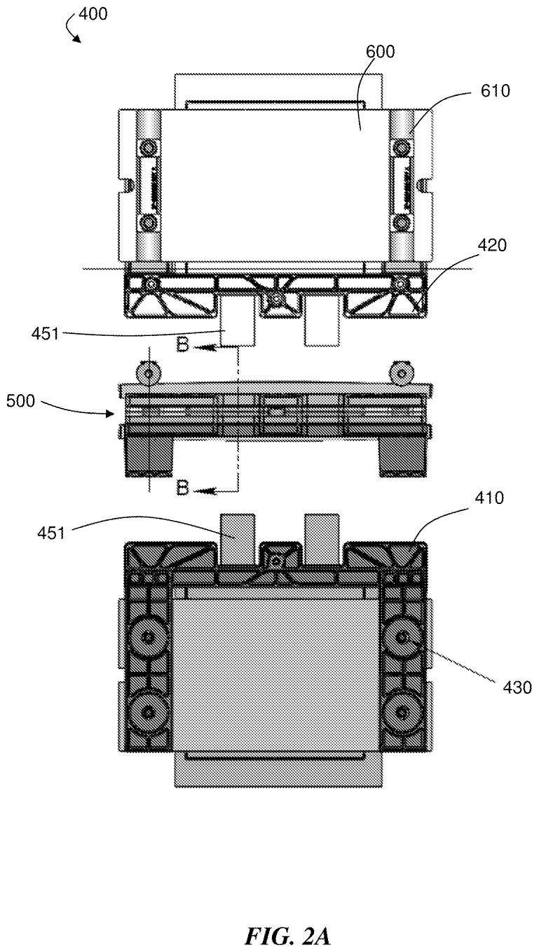

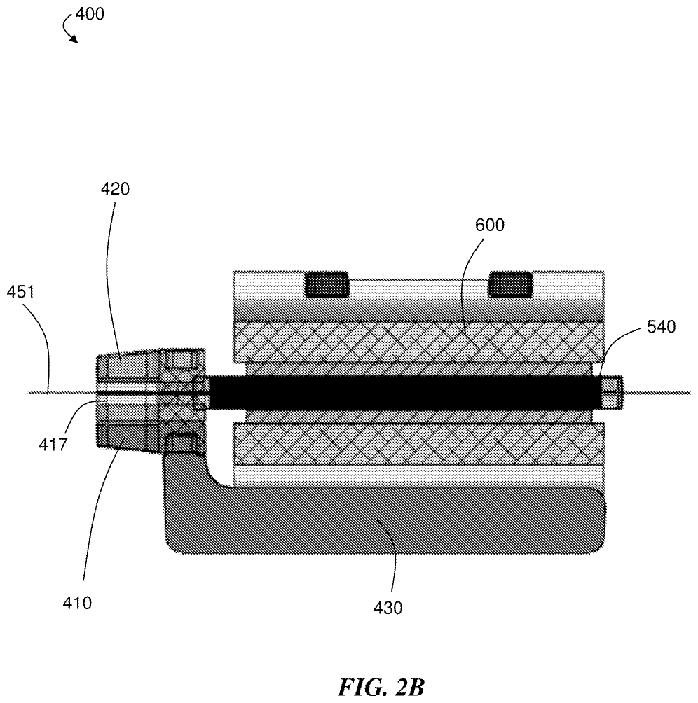

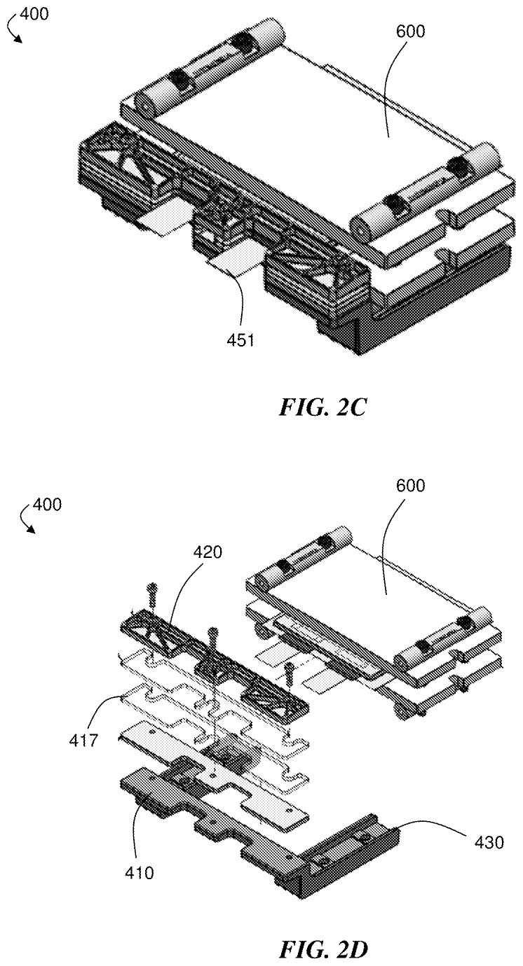

A non-limiting embodiment of certain aspects of the present disclosure is described. In this embodiment, clamp system 400 comprises electrochemical cell 500 comprising an anode (e.g., comprising lithium metal as an anode active material), a cathode (e.g., comprising a lithium-cobalt-magnesium oxide cathode active material), and a liquid electrolyte (e.g., comprising an organic ester solvent and lithium hexafluorophosphate) enclosed by vacuum-sealed foil pouch 540, with electrode tab extension 451 extending through one of the seals of pouch 540. FIG. 2A shows top (top of the figure), side (center of the figure), and bottom (bottom of the figure) view schematic illustrations of exemplary clamp system 400 comprising upper clamp portion 420, lower clamp portion 410, and platform 430 coupled to housing 600 partially enclosing electrochemical cell 500, in accordance with this embodiment. Lower clamp portion 410, upper clamp portion 420, and platform 430 may composed of, for example a glass-reinforced polymeric material (e.g., fabricated using 3D-printing). Housing 600 may include a top solid plate and a bottom solid plate connected by couplings 610. Housing 600 may be configured to apply a force to electrochemical cell 500.

FIG. 2B shows a cross-sectional schematic illustration of clamp system 400 taken from section B-B in FIG. 2A. FIG. 2A further illustrates pouch 540 enclosing electrochemical cell 500 (hidden by pouch 540), with a portion of pouch 540 and electrode tab extension 451 between compressible articles 417, which are in turn between lower clamp portion 410 and upper clamp portion 420. Compressible articles 417 may be made of an elastomeric material such as microcellular polyurethane foam. Lower clamp portion 410 and upper clamp portion 420 may be configured to apply a compressive clamp force to reinforce the seal of pouch 540 through which electrode tab extends, and in some instances also reinforce electronic communication between electrode tab extension 451 and an electrode tab (hidden by pouch 540).

FIGS. 2C-2D show a perspective view schematic illustration and an exploded perspective view schematic illustration, respectively, of clamp system 400 comprising upper clamp portion 420, lower clamp portion 410, platform 430, compressible articles 417, and housing 600 (enclosing and obscuring electrochemical cell 500 except for electrode tab extension 451), according to certain embodiments.

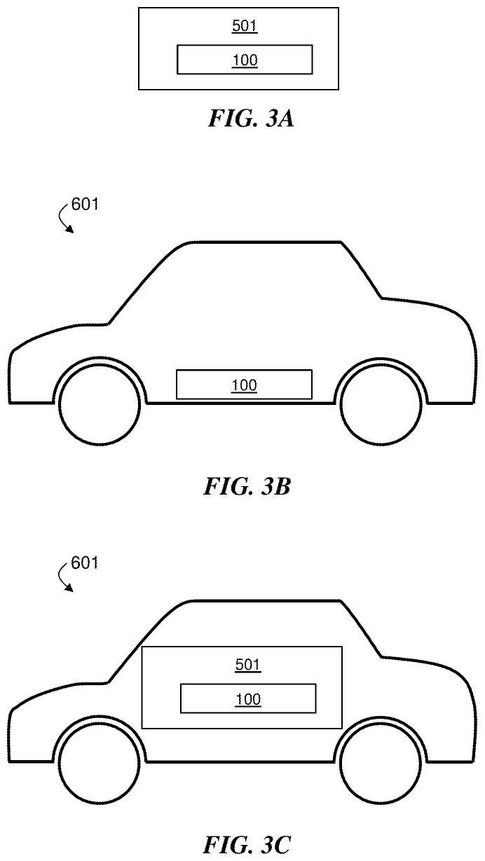

In some embodiments, the clamp system (e.g., comprising an electrochemical cell) described in this disclosure can be integrated into a battery (e.g., a rechargeable battery). FIG. 3A shows a schematic block diagram of battery 501 (e.g., a rechargeable battery) comprising clamp system 100, according to some embodiments.

In some embodiments, the clamp system (e.g., integrated into a battery such as a rechargeable battery) described in this disclosure can be used to provide power to an electric vehicle or otherwise be incorporated into an electric vehicle. As a non-limiting example, clamp systems comprising electrochemical cells described in this disclosure (e.g., integrated into a battery such as a rechargeable battery) can, in certain embodiments, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, spacecraft, and/or any other suitable type of vehicle. FIG. 3B shows a cross-sectional schematic diagram of electric vehicle 601 in the form of an automobile comprising clamp system 100, in accordance with some embodiments. An electrochemical cell of clamp system 100 can, in some instances, provide power to a drive train of electric vehicle 601. For example, clamp system may be integrated into a battery (e.g., a rechargeable battery) that can provide power to a drive train of electric vehicle 601. FIG. 3C shows a cross-sectional schematic diagram of electric vehicle 601 in the form of an automobile comprising battery 501 (e.g., a rechargeable battery) comprising clamp system 100, in accordance with some embodiments. Battery 501 can, in some instances, provide power to a drive train of electric vehicle 601.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on”, “directly adjacent”, “immediately adjacent”, “in direct contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, patented as U.S. Pat. No. 10,862,105 on Dec. 8, 2020 and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. application Ser. No. 14/624,641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. Application Ser. No. 14/848,659 on Sep. 9, 2015, patented as U.S. Pat. No. 11,038,178 on Jun. 15, 2021 and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, patented as U.S. Pat. No. 10,847,833 on Nov. 24, 2020 and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. patent Ser. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “TONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, patented as U.S. Pat. No. 11,024,923 on Jun. 1, 2021 and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021 and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, patented as U.S. Pat. No. 10,944,094 on Mar. 9, 2021 and entitled “PASSIVATING AGENTS FOR ELECTROCHEMICAL CELLS”; U.S. Publication No. US-2018-0277850-A1 published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1 published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1 published on Nov. 23, 2017, filed as U.S. application Ser. No. 15/599,595 on May 19, 2017, patented as U.S. Pat. No. 10,879,527 on Dec. 29, 2020, and entitled “PROTECTIVE LAYERS FOR ELECTRODES AND ELECTROCHEMICAL CELLS”; U.S. Publication No. US-2019-0088958-A1 published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1 published on Nov. 14, 2019, filed as U.S. application Ser. No. 16/470,708 on Jun. 18, 2019, and entitled “PROTECTIVE LAYERS COMPRISING METALS FOR ELECTROCHEMICAL CELLS”; U.S. Publication No. US-2017-0200975-A1 published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1 published Dec. 6, 2018, filed as U.S. application Ser. No. 15/988,182 on May 24, 2018, and entitled “TONICALLY CONDUCTIVE COMPOUNDS AND RELATED USES”; U.S. Publication No. US-2018-0254516-A1 published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1 published Feb. 6, 2020, filed as U.S. Application No. 16,527,903 on Jul. 31, 2019, and entitled “MULTIPLEXED CHARGE DISCHARGE BATTERY MANAGEMENT SYSTEM”; U.S. Publication No. US-2020-0220146-A1 published Jul. 9, 2020, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1 published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1 published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”, U.S. Publication No. US-2020-0373578-A1 published Nov. 26, 2020, filed as U.S. application Ser. No. 16/879,861 on May 21, 2020, and entitled “ELECTROCHEMICAL DEVICES INCLUDING POROUS LAYERS”, U.S. Publication No. US-2020-0373551-A1 published Nov. 26, 2020, filed as U.S. application Ser. No. 16/879,839 on May 21, 2020, and entitled “ELECTRICALLY COUPLED ELECTRODES, AND ASSOCIATED ARTICLES AND METHODS”, U.S. Publication No. US-2020-0395585-A1 published Dec. 17, 2020, filed as U.S. application Ser. No. 16/057,050 on Aug. 7, 2018, and entitled “LITHIUM-COATED SEPARATORS AND ELECTROCHEMICAL CELLS COMPRISING THE SAME”, U.S. Publication No. US-2021-0057753-A1 published Feb. 25, 2021, filed as U.S. application Ser. No. 16/994,006 on Aug. 14, 2020, and entitled “ELECTROCHEMICAL CELLS AND COMPONENTS COMPRISING THIOL GROUP-CONTAINING SPECIES”, U.S. Publication No. US-2021-0135297-A1 published on May 6, 2021, filed as U.S. application Ser. No. 16/670,905 on Oct. 31, 2019, and entitled SYSTEM AND METHOD FOR OPERATING A RECHARGEABLE ELECTROCHEMICAL CELL OR BATTERY″, U.S. Publication No. US-2021-0138673-A1 published on May 13, 2021, filed as U.S. application Ser. No. 17/089,092 on Nov. 4, 2020, and entitled “ELECTRODE CUTTING INSTRUMENT”, U.S. Publication No. US-2021-0135294-A1 published on May 6, 2021, filed as U.S. application Ser. No. 16/670,933 on Oct. 31, 2019, patented as U.S. Pat. No. 11,056,728 on Jul. 6, 2021 and entitled “SYSTEM AND METHOD FOR OPERATING A RECHARGEABLE ELECTROCHEMICAL CELL OR BATTERY”; U.S. Publication No. US-2021-0151839-A1 published on May 20, 2021, filed as U.S. application Ser. No. 16/952,177 on Nov. 19, 2020, and entitled “BATTERIES, AND ASSOCIATED SYSTEMS AND METHODS”; U.S. Publication No. US-2021-0151830-A1 published on May 20, 2021, filed as U.S. application Ser. No. 16/952,235 on Nov. 19, 2020, and entitled “BATTERIES WITH COMPONENTS INCLUDING CARBON FIBER, AND ASSOCIATED SYSTEMS AND METHODS”; U.S. Publication No. US-2021-0151817-A1 published on May 20, 2021, filed as U.S. application Ser. No. 16/952,228 on Nov. 19, 2020, and entitled “BATTERY ALIGNMENT, AND ASSOCIATED SYSTEMS AND METHODS”; U.S. Publication No. US-2021-0151841-A1 published on May 20, 2021, filed as U.S. application Ser. No. 16/952,240 on Nov. 19, 2020, and entitled “SYSTEMS AND METHODS FOR APPLYING AND MAINTAINING COMPRESSION PRESSURE ON ELECTROCHEMICAL CELLS”; U.S. Publication No. US-2021-0151816-A1 published on May 20, 2021, filed as U.S. application Ser. No. 16/952,223 on Nov. 19, 2020, and entitled “THERMALLY INSULATING COMPRESSIBLE COMPONENTS FOR BATTERY PACKS”; U.S. Publication No. US-2021-0151840-A1 published on May 20, 2021, filed as U.S. application Ser. No. 16/952,187 on Nov. 19, 2020, and entitled “COMPRESSION SYSTEMS FOR BATTERIES”; U.S. Publication No. US-2021-0193984-A1 published on Jun. 24, 2021, filed as U.S. application Ser. No. 17/125,124 on Dec. 17, 2020, and entitled “SYSTEMS AND METHODS FOR FABRICATING LITHIUM METAL ELECTRODES”; U.S. Publication No. US-2021-0193985-A1 published on Jun. 24, 2021, filed as U.S. application Ser. No. 17/125,110 on Dec. 17, 2020, and entitled “LITHIUM METAL ELECTRODES AND METHODS”; U.S. Publication No. US-2021-0193996-A1 published on Jun. 24, 2021, filed as U.S. application Ser. No. 17/125,070 on Dec. 17, 2020, and entitled “LITHIUM METAL ELECTRODES”; U.S. Publication No. US-2021-0194069-A1 published on Jun. 24, 2021, filed as U.S. application Ser. No. 17/126,390 on Dec. 18, 2020, and entitled “SYSTEMS AND METHODS FOR PROVIDING, ASSEMBLING, AND MANAGING INTEGRATED POWER BUS FOR RECHARGEABLE ELECTROCHEMICAL CELL OR BATTERY”. All other patents and patent applications disclosed herein are also incorporated by reference in their entirety for all purposes.

U.S. Provisional Patent Application No. 63/060,166, filed Aug. 3, 2020, and entitled “Electrochemical Cell Clamps and Related Methods,” is incorporated herein by reference in its entirety for all purposes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A clamp system for an electrochemical cell comprising electrodes at least partially enclosed by a flexible container, the clamp comprising:
a lower clamp portion;
an upper clamp portion coupled to the lower clamp portion;
a platform adjacent to the lower clamp portion;
the electrochemical cell on the platform, the electrochemical cell at least partially enclosed by a housing; and
a compressible article between the lower clamp portion and the upper clamp portion;
wherein:
at least a portion of the flexible container of the electrochemical cell is between the lower clamp portion and the upper clamp portion;
the electrochemical cell comprises lithium metal and/or a lithium metal alloy as an electrode active material during at least a portion of a charging and/or discharging process of the electrochemical cell;
the electrochemical cell comprises an electrode tab and an electrode tab extension in electronic communication with at least one of the electrodes, at least a portion of the electrode tab being between the lower clamp portion and the upper clamp portion and extending through a seal between a first portion of the flexible container and a second portion of the flexible container;
the lower clamp portion and the upper clamp portion are configured to apply a compressive clamp force to reinforce the seal and/or reinforce electronic communication between the electrode tab and the electrode tab extension; and
the housing is configured to apply, during at least one period of time during charge and/or discharge of the electrochemical cell, an anisotropic force with a component normal to an electrode active surface of at least one electrode of the electrochemical cell.

2. A clamp system for an electrochemical cell comprising electrodes at least partially enclosed by a flexible container, the clamp comprising:
a lower clamp portion;
an upper clamp portion coupled to the lower clamp portion; and
a platform adjacent to the lower clamp portion capable of supporting the electrochemical cell;
wherein:
the lower clamp portion and the upper clamp portion are configured to apply a compressive clamp force to reinforce a contact between a first portion of the flexible container and a second portion of the flexible container.

3. A clamp system for an electrochemical cell comprising electrodes at least partially enclosed by a flexible container, the clamp comprising:
a lower clamp portion;
an upper clamp portion coupled to the lower clamp portion; and
the electrochemical cell, wherein at least a portion of the flexible container of the electrochemical cell is between the lower clamp portion and the upper clamp portion;
wherein:
the lower clamp portion and the upper clamp portion are configured to apply a compressive clamp force to reinforce a contact between a first portion of the flexible container and a second portion of the flexible container.

4. A clamp system for an electrochemical cell comprising an electrode in electronic communication with an electrode tab and an electrode tab extension, the clamp comprising:
a lower clamp portion;
an upper clamp portion coupled to the lower clamp portion; and
the electrochemical cell, wherein at least a portion of the electrode tab and/or electrode tab extension is between the lower clamp portion and the upper clamp portion;
wherein:
the lower clamp portion and the upper clamp portion are configured to apply a compressive clamp force to reinforce electronic communication between the electrode tab and the electrode tab extension.

5. The clamp system of claim 2, further comprising the electrochemical cell on the platform.

6. The clamp system of claim 2, wherein the contact between the first portion of the flexible container and the second portion of the flexible container is a seal.

7. The clamp system of claim 4, further comprising a flexible container at least partially enclosing the electrode.

8. The clamp system of claim 4, wherein the at least a portion of the flexible container is between the lower clamp portion and the upper clamp portion.

9. The clamp system of claim 1, wherein the upper clamp portion and the lower clamp portion are coupled via one or more fasteners.

10. The clamp system of claim 6, wherein a portion of an electrode tab extension, which is in electronic communication with an electrode tab and at least one of the electrodes, extends through the seal and is between the lower clamp portion and the upper clamp portion.

11. The clamp system of claim 10, wherein the upper clamp portion and the lower clamp portion are configured to apply a compressive clamp force to at least a portion of electrochemical cell to reinforce electronic communication between the electrode tab and the electrode tab extension.

12. The clamp system of claim 2, further comprising a compressible article between the lower clamp portion and the upper clamp portion.

13. The clamp system of claim 2, wherein the electrochemical cell is at least partially enclosed by a housing.

14. The clamp system of claim 1, wherein the lower clamp portion, the upper clamp portion, and the platform are configured to complement the shape of the housing.

15. The clamp system of claim 13, wherein the housing is configured to apply, during at least one period of time during charge and/or discharge of the electrochemical cell, an anisotropic force with a component normal to an electrode active surface of at least one electrode of the electrochemical cell.

16. The clamp system of claim 2, wherein at least one electrode of the electrochemical cell comprises lithium metal and/or a lithium metal alloy as an electrode active material during at least a portion of a charging and/or discharging process of the electrochemical cell.

17. The clamp system of claim 1, wherein the electrochemical cell comprises lithium metal and/or a lithium metal alloy as an electrode active material during all of a charging and/or discharging process of the electrochemical cell.

18. A rechargeable battery, comprising the clamp system of claim 1.

19. An electric vehicle, comprising the rechargeable battery of claim 18.

20. A method, comprising:
applying a compressive clamp force, via a clamp, to at least a portion of a flexible container containing electrodes and a liquid electrolyte, such that the compressive clamp force reinforces a contact between a first portion of the flexible container and a second portion of the flexible container.

21. A method, comprising:
applying a compressive clamp force, via a clamp, to at least a portion of a flexible container of an electrochemical cell such that the flexible container remains fluid-tight in at least one condition under which the flexible container would otherwise fail.

22-32. (canceled)
